(19) United States
(12) Patent Application Publication
(10) Pub. No.: US 2011/0303506 A1
(43) Pub. Date: Dec. 15, 2011

(54) Clutch-Release Bearing Device including a Wear Ring

(75) Inventors: Sylvain Bussit, Monnaie (FR); Benoit Arnault, Saint Cyr Sur Loire (FR); Mickael Chollet, Saint-Christophe Le Nais (FR)

(73) Assignee: AKTIEBOLAGET SKF, Goteborg (SE)

(21) Appl. No.: 13/157,035

(22) Filed: Jun. 9, 2011

(30) Foreign Application Priority Data
Jun. 9, 2010 (FR) 1054545

(51) Int. Cl. F16D 23/12; F16C 31/04

(52) U.S. Cl. 192/99 A; 192/110 B

(57) ABSTRACT

A clutch-release bearing device includes a bearing having a non-rotating ring, a rotating ring with a rolling portion for supporting rolling elements, a contact portion extending from the rolling portion and radially away from the non-rotating ring, and a guide portion extending toward the non-rotating ring and disposed axially against the contact portion to form a fold, and at least one row of rolling elements disposed between the non-rotating and rotating rings. A wear ring is movably mounted on the guide portion of the rotating ring and is configured to contact the clutch mechanism diaphragm. The ring includes a polymeric body and a stiffening insert configured to stiffen the body, the body having a retaining portion disposed generally axially between the rotating ring rolling and contact portions and configured to axially retain the wear ring in relation to the rotating ring.

### CROSS-REFERENCE TO RELATED APPLICATIONS

This application claims priority to French patent application no. FR 1054545, filed on Jun. 9, 2010, which is incorporated fully herein by reference.

### BACKGROUND OF THE INVENTION

The present invention relates to the field of clutch-release bearing devices intended to act on the diaphragm of a clutch, in particular for a motor vehicle.

A clutch release bearing device typically includes a rolling-contact bearing, one of the rings of which is a rotating ring and the other is a fixed ring, the rotating ring being provided with a radial leading surface which is intended to come into contact with the end of the fingers that make up the diaphragm of the clutch. A plurality of rolling elements are disposed between the rotating ring and the fixed ring and are evenly distributed regularly in the circumferential direction by means of a cage.

A non-rotating operating element supports the rolling-contact bearing and, under the action of a mechanical, electrical or hydraulic control member, moves the rolling-contact thrust bearing axially in order to press the leading surface of the rotating ring against the clutch diaphragm and to actuate the clutch mechanism or system.

In order to limit wear by friction between the fingers of the diaphragm and the leading surface of the rotating ring during clutch-release and clutch-engagement operations, it is possible to provide a wear ring made of plastic on the leading surface. For more details, reference could be made, for example, to patent application US-A 1-2006/0081439.

Also known, from U.S. Pat. No. 6,684,997, is a clutch-release bearing device having a rolling-contact bearing, a friction ring fixed to the rotating outer ring of the bearing, and a thrust ring which rests on the friction ring and is able to move in relation thereto while in contact with the clutch diaphragm.

The thrust ring is retained axially in relation to the rolling-contact bearing by way of a plate fixed to the non-rotating inner ring of the bearing, or by the friction ring which in this case is crimped to the rotating outer ring by a plate.

In order to limit the wear between the fingers of the diaphragm and the rolling-contact bearing and to axially retain the thrust ring in relation to the bearing, the bearing device of the document comprises a large number of elements to be assembled.

### SUMMARY OF THE INVENTION

The present invention aims to remedy the drawbacks discussed above. More particularly, the present invention aims to provide a particularly economical clutch-release bearing device which is easy to mount and which, prior to mounting, has a limited risk of the elements of which it is made coming apart.

In one aspect, the present invention is a clutch-release bearing device for a clutch mechanism having a diaphragm. The bearing device comprises a bearing with a central axis and including a non-rotating ring, a rotating ring with a rolling portion for supporting rolling elements, a contact portion extending from the rolling portion and generally radially away from the non-rotating ring, and a guide portion extending generally toward the non-rotating ring and disposed generally axially against the contact portion so as to form a fold, and at least one row of rolling elements disposed between the non-rotating and rotating rings. A wear ring is mounted on the guide portion of the rotating ring so as to be movable with respect to the rotating ring, the wear ring being configured to contact the clutch mechanism diaphragm and including a polymeric body and a stiffening insert configured to stiffen the body. The wear ring body has a retaining portion disposed generally axially between the rotating ring rolling and contact portions and configured to axially retain the wear ring in relation to the rotating ring.

The wear ring mounted directly in contact with the rotating ring of the rolling-contact bearing itself comprises the means provided for engaging with the rotating ring in order to axially retain the wear ring with respect to the rolling-contact bearing. The wear ring is able to come into direct contact with a clutch mechanism diaphragm. The clutch-release bearing device forms a unitary assembly that can be stored, transported and mounted with a particularly low risk of the elements of which it is made accidentally coming apart.

Furthermore, the production of a wear ring having a stiffening insert increases the mechanical strength of the ring with respect to the axial forces transmitted between the rotating ring and the clutch mechanism diaphragm. In addition, with the formation of the fold, the mechanical strength of the rotating ring is increased in the contact region of the wear ring, with a reduced axial space requirement. The phenomenon of stresses being concentrated on the rotating ring in the contact region of the wear ring is limited.

In one embodiment, the wear ring is capable of angular or tilting movement with respect to the rotating ring such that the rotational axis of the wear ring can be tilted at an angle with respect to the rotational axis of the rolling-contact bearing. The wear ring can thus adapt to the angular misalignment between the rotational axes of the rolling-contact bearing and the associated clutch mechanism diaphragm.

In one embodiment, the body of the wear ring comprises retaining means. The retaining means can engage with the rotating ring by diametric interference.

Advantageously, the retaining means comprise at least one protuberance that forms a hook extending at least radially in the direction of the rotating ring. In one embodiment, the retaining means comprise a plurality of tongues that are spaced apart from one another in the circumferential direction. Alternatively, the retaining means comprise an annular flange.

In one embodiment, the wear ring is mounted in a manner resting against a guide portion of the rotating ring that extends obliquely towards the non-rotating ring.

In one embodiment, the oblique portion of the rotating ring extends radially towards the inside and the guide portion radially towards the outside. The retaining means are able to engage with a connecting portion that connects the contact portion and the guide portion of the rotating ring.

Advantageously, the rotating ring is in one piece.

In one embodiment, a front surface of the body of the wear ring that is able to come into contact with the clutch mechanism diaphragm comprises projections that are configured to form anti-rotating means of the wear ring in relation to the diaphragm in the circumferential direction. The projections can be in the form of rectilinear ribs that extend radially over the front surface of the body of the wear ring. Advantageously, each finger or tooth of the clutch mechanism diaphragm rests axially against the frontal surface and is located between two consecutive ribs in the circumferential direction.

The invention also relates to a clutch control system comprising a control fork, a clutch mechanism diaphragm and a clutch-release bearing device as defined hereinabove.

### BRIEF DESCRIPTION OF THE SEVERAL VIEWS OF THE DRAWINGS

The present invention will be better understood from studying the detailed description of certain embodiments taken by way of non-limiting example and illustrated in the appended drawings, in which:

FIGS. 1 and 2 are views in axial section of a clutch-release bearing device according to a first embodiment of the invention, in the free state and the mounted state,

FIG. 3 is a detail view of FIG. 1,

FIG. 4 is a perspective view of the inner ring of the device from FIGS. 1 to 3,

FIG. 5 is a view in axial section of a clutch-release bearing device according to a second embodiment of the invention, in the free state,

FIG. 6 is a front view of the wear ring of the device from FIG. 5,

FIG. 7 is a view in axial section of a clutch-release bearing device according to a third embodiment of the invention, in the free state, and

FIG. 8 is a front view of the wear ring of the device from FIG. 7.

### DETAILED DESCRIPTION OF THE INVENTION

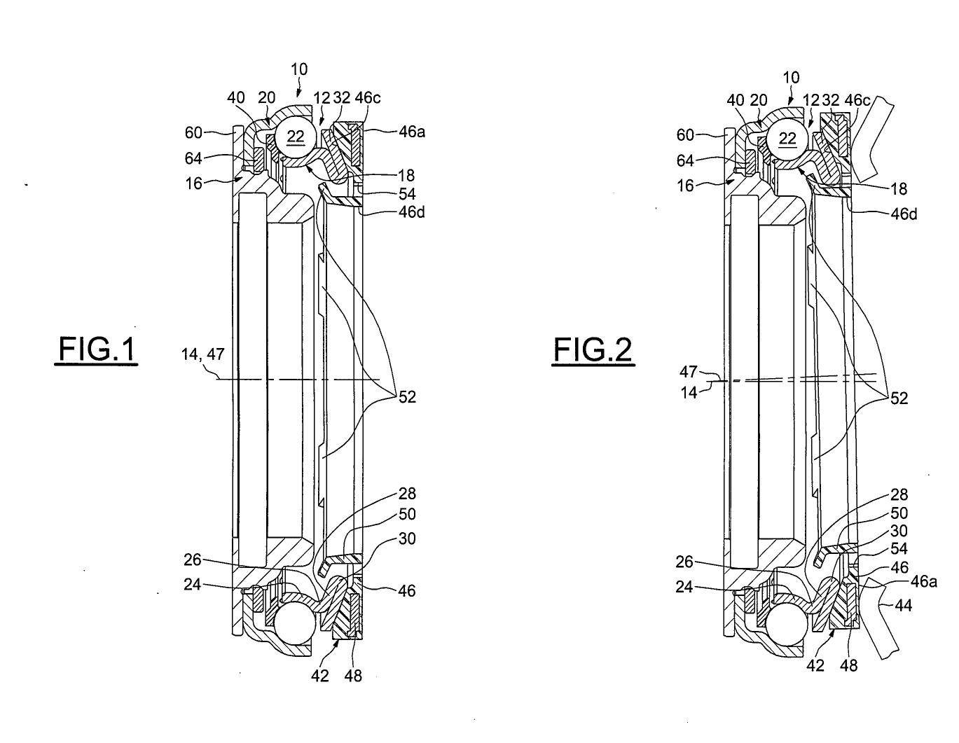

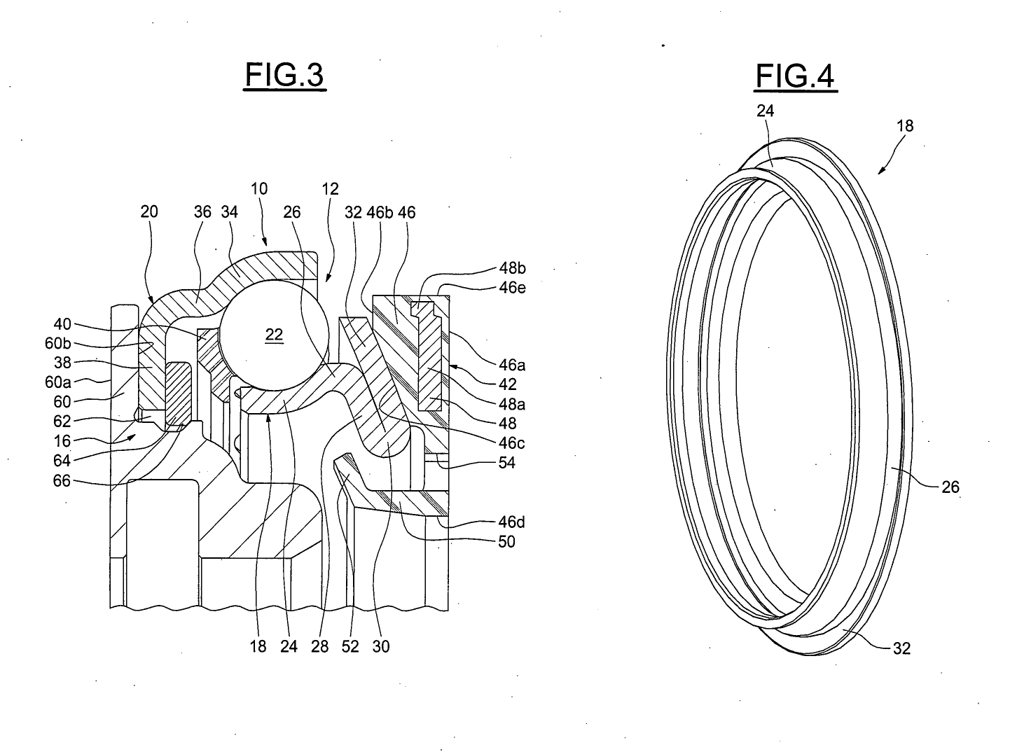

In FIGS. 1 to 4, a clutch-release bearing device 10 basically comprises a rolling-contact bearing 12 with a central rotational axis 14 and a thrust or wear ring 42. The bearing 12 is preferably mounted on an operating element 16, which may be a component separate from the control member that actuates the device or may be an integral part thereof. The rolling-contact bearing 12 has an inner, rotating ring 18, an outer, non-rotating ring 20, and at least one row of rolling elements 22, preferably ball elements, disposed between the rotating and non-rotating rings 18, 20.

Preferably, the inner or rotating ring 18 is thin-walled and produced as a one-piece construction, e.g., by pressing a steel sheet or tube. The ring 18 preferably has a toroidal “rolling” portion 24, which has in cross section a concave internal profile in the form of a quarter circle, forming a raceway for the rolling elements 22. The inner ring 18 also has a short, annular axial portion 26 extending from a large-diameter edge of the toroidal or rolling portion 24 axially opposite the outer ring 20 and an annular oblique portion 28 extending radially inwardly from the axial portion 24 on the opposite side to the toroidal portion 24 and the rolling elements 22. The oblique portion 28 extends generally radially inwards from the axial portion 26 and axially opposite the toroidal portion 24. The small-diameter inside edge of the oblique portion 28 is prolonged by a rounded portion 30 over approximately 180°. The inside diameter of the rounded portion 30 is less than the inside diameter of the toroidal portion 24. In other words, the small-diameter inside edge of the rounded portion 30 is offset radially inwards with respect to the toroidal portion 24 and the axial portion 26.

The inner, rotating ring 18 also has a generally annular oblique portion 32 extending from the rounded portion 30 and generally radially outwardly toward the outer ring 20 and disposed generally axially against the oblique portion 28. Thus, the rounded portion 30 connects the oblique portions 28, 32, with the oblique portions 28, 32 being inclined with respect to a radial plane. The oblique portion 32 is folded over axially against the oblique portion 28 so as to form a fold and obtain locally a double thickness of material. The oblique portion 32 extends radially beyond the axial portion 26 on the opposite side to the oblique portion 28. The large-diameter, peripheral outside edge of the oblique portion 32 is offset radially outwards with respect to the toroidal portion 24 and the axial portion 26. The inner surface of the oblique portion 32 rests against the outer surface of the oblique portion 28. The outer surface of the oblique portion 32 is convex and defines a spherical portion, the centre of which coincides with the axis 14 of the rolling-contact bearing and is offset axially towards the outside with respect to the outer ring 20.

Preferably, the outer, non-rotating ring 20 is also preferably generally thin-walled and formed of one-piece construction, such as by pressing a steel sheet or tube. The ring 20 has toroidal portion 34 having in cross section a concave internal profile in the form of a quarter circle, providing a raceway for the rolling elements 22. The toroidal portion 34 is prolonged axially on the opposite side to the inner ring 18 by an annular axial portion 36. Axially on the opposite side to the toroidal portion 34, the axial portion 36 is prolonged radially inwards by an annular radial portion 38.

The rolling-contact bearing 12 also has a retaining cage 40 for maintaining the even circumferential spacing of the rolling elements 22, the retaining cage 40 being located radially between the toroidal portion 24 of the inner ring 18 and the axial portion 36 of the outer ring 20. The retaining cage 40 is mounted axially between the rolling elements 22 and the radial portion 38 of the outer ring 20. It is located axially opposite the oblique portions 28, 32 of the inner ring 18 when considering the rolling elements 22.

The thrust ring or wear ring 42 is disposed generally against the outer surface of the oblique portion 32 of the inner ring 18 and is configured to engage by contact with a diaphragm 44 in order to actuate a clutch mechanism or system. The wear ring 42 is mounted in a manner resting against the guide portion 32 of the inner, rotating ring 18 axially on the opposite side to the oblique portion 28 of the inner ring 18.

The wear ring 42 preferably has a generally annular body 46 with a central axis 47 and a stiffening insert 48 fixed to the body. In the embodiment illustrated, the body 46 is overmolded on the insert 48 and is formed of a polymeric material (e.g., a plastic), for example unfilled, mineral fiber-filled or carbon-filled polyamide. The stiffening insert 48 is produced from a material that is more rigid than that of the body 46, for example from metal or plastic.

The body 46 of the wear ring has an annular radial surface 46a, which is provided to engage by contact with the diaphragm 44, and an opposite annular radial surface 46b, the small-diameter edge of which is prolonged by a concave surface 46c which has a matching shape and is in contact with the convex outer surface of the oblique portion 32 of the inner ring 18. During the mounting of the wear ring 42 on the inner ring 18, the oblique portion 32 centers the body 46 on the ring.

The body 46 also has an axial bore 46d, the diameter of which is less than the diameter of the rounded portion 30 of the inner ring 18, and a cylindrical outer surface 46e. The body 46 further has an annular axial portion 50 prolonging the bore 46d axially next to the inner ring 18. A radial space exists between the axial portion 50 and the rounded portion 30 of the inner ring 18. This space is sufficient to allow tilting of the wear ring 42 without interference between the portions, as is described hereinbelow.

The wear ring 42 has a retaining portion disposed generally axially between the rotating ring rolling and contact portions 24, 28 and configured to axially retain the wear ring 42 in relation to the rotating ring. In one embodiment, the retaining portion is provided by protuberances in the form of tongues 52 extending from an axial end of the axial portion 50 obliquely and radially toward the inner ring 18. The tongues 52 preferably include six tongues 52 spaced circumferentially apart about the wear ring axis 47. The tongues 52 may have, for example, a circumferential dimension of between 10 and 30 degrees and are situated axially between the toroidal portion 24 and the oblique portion 28 of the inner ring 18, while remaining axially spaced apart from the axial portion 28. Further, the tongues 52 have an outside diameter greater than the inside diameter of the rounded portion 30 of the inner ring 18, so that the wear ring 42 can be retained axially in relation to the inner ring 18 by diametric interference between the tongues 52 and the ring. The tongues 52 form hooks that are able to engage with the inner ring 18 in order to secure these two elements axially such that the bearing device 10 forms a unitary assembly that can be handled, transported and mounted in a single operation.

As indicated hereinabove, in the embodiment illustrated, the body 46 is overmolded on the stiffening insert 48 in order to obtain the wear ring 42. In order to enable axial demolding of the wear ring 42 thus formed, in particular of the tongues 52, the body 46 has, axially opposite each tongue, a through-hole 54 formed axially near the bore 46d and having a circumferential dimension equal to that of the tongues.

The stiffening insert 48 is preferably formed as a substantially flat washer. In the embodiment illustrated, the insert 48 has an annular radial portion 48a located in the vicinity of the radial surface 46a of the body 46 and prolonged at a large-diameter edge by a radial flange 48b that is partially offset axially with respect to the radial portion 48a so as to increase the rigidity of the wear ring 42. The flange 48b is located in the vicinity of the outer surface 46e of the body 46.

In the embodiment illustrated, the stiffening insert 48 is entirely embedded inside the body 46 of the wear ring 42. Alternatively, it is possible to provide an insert that is partially embedded inside the body. In another alternative embodiment, it could also be possible to fix the body 46 to the stiffening insert 48 by any other appropriate means, for example by adhesive bonding.

The operating element 16 has an axis 14 and can be produced from molded plastic, for example from polyamide, or else from metal. The operating element 16 is a component separate from a control fork (not shown), which fork is able to exert an axial force on the element in order to move the device 10 as a whole during a clutch-release operation. The operating element 16 has to this end a radial flange 60 provided with a contact surface 60a oriented towards the rear of the bearing device 10 and able to engage with the control fork. The flange 60 also has an opposite contact surface 60b which is oriented towards the front and is in frictional contact with the radial portion 38 of the outer ring 20. There is a radial clearance 62 between an approximately cylindrical outer surface of the operating element 16 and the small-diameter edge of the radial portion 38, such that a certain radial movement of the rolling-contact bearing 12 can take place with respect to the operating element 16 and the bearing can thus self-align in the radial direction.

A retaining washer 64 is mounted in a groove 66 made in the outer surface of the operating element so as to axially secure the operating element 16 to the rolling-contact bearing 12. The washer 64 comes to rest against the radial portion 38 of the outer ring 20 axially on the opposite side to the flange 60 of the operating element 16.

As illustrated in FIG. 1, in a neutral position of the device 10 before it is mounted on the clutch system diaphragm, the axis 47 of the wear ring 42 is coaxial with the axis 14 of the rolling-contact bearing 12.

When the device 10 is fitted on the diaphragm 44 with an axial preload, the wear ring 42 can angularly displace with respect to the mounting portion of the rotating ring 18 so as to adapt to angular misalignments that exist between the axis 14 of the rolling-contact bearing 12 and the axis of the diaphragm 44. Specifically, during contact between the diaphragm 44 and the front radial surface 46a of the wear ring 42, the ring 42 can tilt at an angle with respect to the axis 14 such that its axis 47 is aligned with the axis of the diaphragm. In FIG. 2, the axis 47 of the wear ring 42 is angularly misaligned with respect to the axis 14 in the anticlockwise direction while remaining in a single radial plane. Of course, tilting of the wear ring 42 can also occur in the clockwise direction. The angular tilting of the axis 47 in relation to the axis 14 is for example less than 3 degrees, in particular around 2 degrees.

The swiveling capacity of the wear ring 42 in relation to the rotating inner ring 18, and more generally with respect to the rolling-contact bearing 12, allows the angular self-alignment of the axis 47 of the ring on the axis of the diaphragm and allows the axis to adapt in this way to the angular misalignment between the axis of the diaphragm and the axis 14.

The wear ring 42 can pivot on the oblique portion 32 of the inner ring 18 while remaining in contact with the outer surface of the portion. The oblique portion 32 thus performs a function of centering the wear ring 42 while it is mounted on the inner ring 18, and a function of guiding the ring while it tilts when the device 10 is fitted on the diaphragm 44.

Before the device 10 is mounted, during any angular tilting of the wear ring 42, the tongues 52, by engaging with the inner ring 18, ensure the axial retention of the wear ring 42 on the rolling-contact bearing 12.

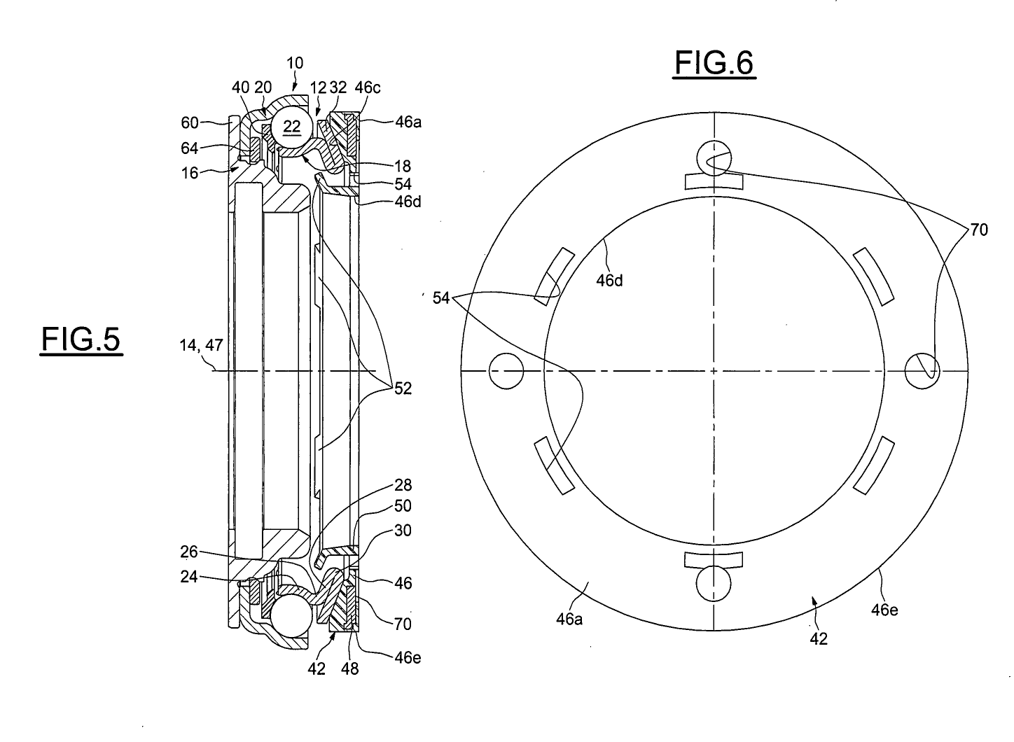

The embodiment illustrated in FIGS. 5 and 6, in which the identical elements have the same references, differs from the embodiment described hereinabove in that the wear ring 42 has recesses 70 made starting from the radial surface 46a and extending axially as far as a small-diameter edge of the radial portion 48a of the stiffening insert 48. There are four recesses 70, which have a generally circular shape and are spaced apart from one another evenly in the circumferential direction. They are located radially between the outer surface 46e and the openings 54, in the vicinity of the openings. The recesses 70 result from keeping the stiffening insert 48 in position during the overmolding of the body 46 of the wear ring.

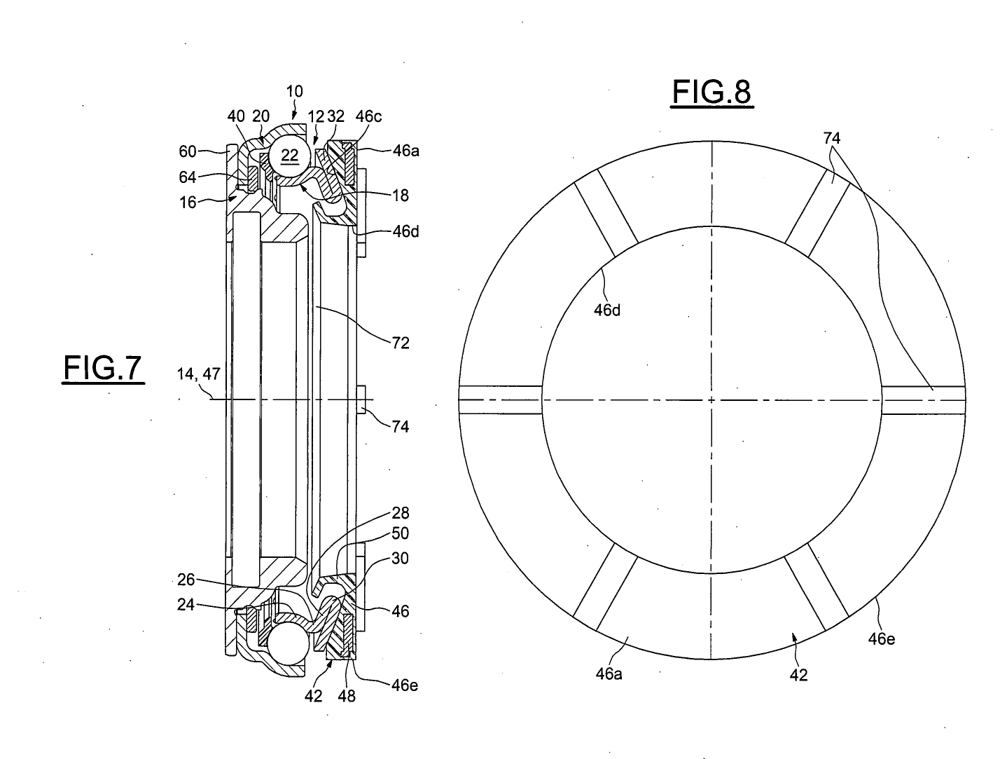

The alternative embodiment illustrated in FIGS. 7 and 8, in which the identical elements have the same reference numbers, differs from the first embodiment described in that the retaining portion of the wear ring 42 is provided by a single annular rim or flange 72, as opposed to a plurality of tongues 52 spaced apart in the circumferential direction. The orientation of the flange 72 is generally identical to that of the tongues 52. The flange 72, which extends from the axial portion 50 obliquely towards the outside, is able to engage with the rounded portion 30 of the inner ring 18 by diametric interference in order for the wear ring 42 to be retained axially in relation to the inner ring. In this embodiment, the wear ring 42 does not have the openings 54 illustrated in the embodiment of FIGS. 1 to 4, the ring being demolded by virtue of sliders.

In the alternative embodiment, the wear ring 42 has, on its radial surface 46a, axial projections 74 that extend towards the outside. The projections 74 are produced here in the form of rectilinear ribs that extend radially from the bore 46d as far as the cylindrical outer surface 46e. There are six projections here that are spaced apart evenly from one another in the circumferential direction on the radial surface 46a. The projections 74 are integral with the wear ring 46.

Each finger of the clutch mechanism diaphragm is contactable with the radial surface 46a by being positioned between two projections 74 that succeed one another immediately in the circumferential direction. The projections 74 limit possible rotation of the wear ring 42 in the circumferential direction with respect to the clutch mechanism diaphragm. The projections 74 prevent relative rotation between the wear ring 42 and the diaphragm. Of course, it is also possible to provide, for the other embodiments described, a wear ring having such anti-rotation means.

In all of the embodiments illustrated, the retaining portion of the wear ring are able to engage with the rounded portion 30 of the inner ring 18 connecting the oblique portions 28, 32 in order to axially retain the wear ring 42 on the rolling-contact bearing 12. Alternatively, the retaining portion of the wear ring may engage with a different portion of the rotating inner ring 18, for example the oblique portion 28.

In another alternative construction, it is also possible to provide a different design of the inner ring 18 which may comprise, for example, portions 28, 32 that extend radially.

In the embodiments illustrated, the outer ring 20 is a non-rotating ring and the inner ring 18 is a rotating ring. Alternatively, it could also be possible to provide a non-rotating inner ring and a non-rotating outer ring.

The invention provides a clutch-release bearing device that forms a unitary assembly that can be stored, transported and handled while limiting the risk of the elements of which it is made coming apart by virtue of the provision of a wear ring having retaining means that are able to engage with complementary retaining means formed on the rotating ring of the rolling-contact bearing.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A clutch-release bearing device for a clutch mechanism, the clutch mechanism having a diaphragm, the bearing device comprising:
a bearing with a central axis and including a non-rotating ring, a rotating ring with a rolling portion providing a raceway for rolling elements, a contact portion extending from the rolling portion and generally radially away from the non-rotating ring, and a guide portion extending generally toward the non-rotating ring and disposed generally axially against the contact portion so as to form a fold, and at least one row of rolling elements disposed between the rotating and non-rotating rings; and
a wear ring mounted on the guide portion of the rotating ring so as to be movable with respect to the rotating ring, the wear ring being configured to contact the clutch mechanism diaphragm and including a polymeric body and a stiffening insert configured to stiffen the body, the body having a retaining portion disposed generally axially between the rotating ring rolling and contact portions and configured to axially retain the wear ring in relation to the rotating ring.

2. The bearing device according to claim 1 wherein the wear ring has a central axis and is angularly displaceable with respect to the mounting portion of the rotating ring such that the axis of the wear ring can be tilted at an angle with respect to the axis of the bearing.

3. The bearing device according to claim 1 wherein the retaining portion of the wear ring engages with the rotating ring by diametric interference.

4. The bearing device according to claim 1 wherein the retaining portion of the wear ring includes at least one protuberance forming a hook extending at least partially radially toward the rotating ring.

5. The bearing device according to claim 4 wherein the wear ring has a central axis and the at least one protuberance includes a plurality of tongues spaced circumferentially about the axis.

6. The bearing device according to claim 4, wherein the at least one protuberance includes an annular flange.

7. The bearing device according to claim 1, wherein the guide portion of the wear ring extends generally obliquely towards the non-rotating ring.

8. The bearing device according to claim 1 wherein the retaining portion of the wear ring is configured to engage with a connecting portion of the rotating ring, the connecting portion connecting the contact portion and the guide portion.

9. The bearing device according to claim 1 wherein the wear ring has a central axis and the wear ring body has a front surface and a plurality of projections extending from the front surface and spaced circumferentially about the central axis, the projections being contactable with the clutch mechanism diaphragm so as to prevent relative rotation between the wear ring and the diaphragm.

10. A clutch control system comprising:
a control fork;
a clutch mechanism diaphragm; and
a clutch-release bearing device including:
a bearing with a central axis and having a non-rotating ring, a rotating ring with a rolling portion providing a raceway for rolling elements, a contact portion extending from the rolling portion and generally radially away from the non-rotating ring, and a guide portion extending generally toward the non-rotating ring and disposed generally axially against the contact portion so as to form a fold, and at least one row of rolling elements disposed between the rotating and non-rotating rings, and
a wear ring mounted on the guide portion of the rotating ring so as to be movable with respect to the rotating ring, the wear ring being configured to contact the clutch mechanism diaphragm and including a polymeric body and a stiffening insert configured to stiffen the body, the body having a retaining portion disposed generally axially between the rotating ring rolling and contact portions and configured to axially retain the wear ring in relation to the rotating ring.
